(19) United States
(12) Patent Application Publication
(10) Pub. No.: US 2014/0316928 A1
(43) Pub. Date: Oct. 23, 2014

(54) METHOD AND SYSTEM FOR BUSINESSES TO ACQUIRE PROFITABLE CUSTOMERS

(71) Applicant: Mark Springer, Thousand Oaks, CA (US)

(72) Inventor: Mark Springer, Thousand Oaks, CA (US)

(21) Appl. No.: 14/317,245

(22) Filed: Jun. 27, 2014

Related U.S. Application Data
(63) Continuation-in-part of application No. 12/875,109, filed on Sep. 2, 2010.
Application No. 12/875,109 is a division of application No. 10/830,694, filed on Apr. 23, 2004, now abandoned.

(51) Int. Cl. G06Q 30/06

(52) U.S. Cl. CPC G06Q 30/0611
USPC 705/26.4

(57) ABSTRACT

The disclosure provides a method and system for customers to identify their Financial Value and to auction this value, through a full-time public network, to selected service and product providers (collectively “vendors”) seeking customers with specific profiles.

### CROSS-REFERENCE TO RELATED APPLICATIONS

This applications claims priority to U.S. patent application Ser. No. 12,875,109, filed Apr. 23, 2004, which is hereby incorporated by reference in its entirety.

This application is a Continuation-In-Part application based on the disclosure made in U.S. patent application Ser. No. 12/875,109, filed Sep. 2, 2010, which is hereby incorporated by reference in its entirety.

### FIELD OF THE INVENTION

The present disclosure relates to electronic commerce, and more specifically, to a method for consumers, businesses, and local governments (“customers”) to communicate the customer's financial value and potential profitability to (“vendors”). This may include, but is not limited to financial institutions, pension companies, insurance companies, and other enterprises. Enterprises utilizing the present disclosure will have the opportunity to competitively offer services and products through an auction process based on a full-time public network, and thereby acquire potentially profitable customers.

### BACKGROUND OF THE INVENTION

Customers are the backbone of any commercial undertaking. Customer acquisition, meaning the enticement of suitable, potentially profitable customers is a critical undertaking of sales and marketing. The acquisition of the right customer, at the right acquisition cost is one of the major determinants of a business' profitability.

Customers can be attracted to a business' product offering in a variety of ways. Most products that are offered to customers, are supplemented with information about how such products will enhance their lives, meet a basic need, reduce a fear, serve a convenience, cure an ill, or otherwise fulfill a want. Over the years, the sale and marketing of products have narrowed from an open offering and acceptance (by the customer) to very specific customer segmentation, whereby vendors identify the needs and/or wants of their potential customers, and then subsequently, offer products and/or services designed to satisfy the customer's identified needs.

A market segment is a subgroup of people or organizations sharing one or more characteristics and having similar product needs. The market segmentation concept is now crucial to vendors' market assessment and market strategy. Businesses divide the market into workable market segments—such as (but not limited to) age, income, product type, geography, buying patterns, customer wants, etc. Businesses then define their markets and the products they will sell to those markets.

Segmentation helps vendors plan and focus on the different types of potential customers. Segmentation also helps the marketers understand their competition, and also helps target the same customer money with other products.

In today's business it is easy to see segmentation in action. For example, different tone, content, and media are use for ads that sell products to kids, as compared to ads that sell the same product but which are targeted to parents. In another example, consider how car companies change their advertising substantially from one type of car to another in order to best appeal to different market segments. In developing segmentation, businesses consider what factors make a difference in the purchasing tendencies, media attraction, and value patterns of their target groups.

Market segmentation is the process of dividing a market into distinct subsets (segments) that behave in similar ways or have similar needs. Because each segment is fairly homogeneous in their needs and attitudes, they are likely to respond similarly to a given marketing strategy. That is, they are likely to have similar feelings and ideas about a marketing mix comprised of a given product or service, sold at a given price, distributed by certain methods, and promoted in a certain way.

Broadly, markets can be divided according to a number of general criteria, such as by industry or public versus private sector. Small market segments are often referred to as niche markets or specialty markets.

The process of segmentation is distinct from targeting (choosing which segments to address) and positioning (designing an appropriate marketing mix for each segment). The overall intent of segmentation is to identify groups of similar customers and potential customers; to prioritize the groups to address; to understand their behavior; and to respond with appropriate marketing strategies that satisfy the different preferences of each chosen segment, thus improving revenues.

Improved segmentation can lead to significantly improved marketing effectiveness. With the right segmentation, appropriate lists can be purchased (said lists being databases of potential customers who fall into the identified market segment), advertising results can be improved, and customer satisfaction can be increased.

Numerous variables may be combined in order to develop an in-depth understanding of a segment; this is referred to as “Depth Segmentation”. When enough information is combined to create a clear picture of a typical member of a segment, this is referred to as a “Buyer Profile”. If the Profile is limited to demographic variables it is called a “Demographic Profile” (typically shortened to “a Demographic”). A statistical technique commonly used in determining a Profile is Cluster Analysis.

The original model of segmentation was the top-down approach: You start with the total population and divide it into segments. This evolved into the bottom-up approach. In this technique, you start with a single customer and build on that profile. This typically requires the use of customer relationship management software or a database of some kind. Profiles of existing customers are created and analyzed. Various demographic, behavioral, and psychographic patterns are built up using techniques such as cluster analysis. This process is sometimes called “database marketing”, “micro-marketing”, or “data mining”. Its use is most appropriate in highly fragmented markets. This method treats every customer as a “micromajority”. Others call it a “segment of one marketing”. Through this process mass customization is possible.

However, despite all this information and modeling, at the end of this process of marketing and segmentation, the product is still basically “offered” and awaits a customer's “acceptance”. Marketing is an inexact science. It's also a very public process. Even Direct Mail, which affords some level of privacy, is nonetheless a very mass market, and hardly a private undertaking. Additionally, the use of data mining as a process has created a huge industry of information sellers. The more information a business has on its individual customers, the more tailored its marketing strategy can be, resulting in its offers enjoying a greater chance of success. For example, if a customer is buying a house, then that individual is a legitimate potential consumer for home inspectors, insurance companies, furniture stores, home improvement contractors, mortgage brokers, etc., and a whole host of specialty companies that deal with ever increasing levels of associated micro-markets. The problem with this form of marketing, however, is that none of these companies know the customer's precise priority, her willingness to allocate scarce resources, when precisely the customer will make a decision, or what other factors can impact how a customer evaluates all these offers.

An additional problem is that privacy is under constant attack. Information is valuable. The result of this is that regardless of the data mining efforts, finding out what a customer needs, when they need it, offering it on acceptable terms, getting them to close, and satisfactorily delivering the service is notoriously difficult and expensive. Consider that, in general, a direct mail solicitation could yield from zero to less than 1% response. Fundamentally, 99% of the effort was waste. That waste is a cost that is then passed on to the 1%. Most consumers not only feel violated as to the lack of privacy but also fail to enjoy the benefits of their personal information that is theirs to share and have valued.

The material disclosed herein (referred throughout this disclosure as “Financial Value”) represents a fundamental departure in both the approach and process related to customer information based marketing in order to address the following deficiencies in the current system:

1) Instead of vendors offering unnecessary products to unprofitable customers, this new process will allow customers to self-identify and auction their Financial Value to vendors. This will in turn eliminate the need for businesses to incur the considerable cost inefficiencies of attempting to identify and evaluate potential profitable customers by allowing customers to self-identify their market segment information and provide it directly to the vendors.

3) Afford complete privacy and anonymity for both parties until terms are reached.

4) Encourage customers to seek the very best terms from the most efficient service-providers.

5) Permit customers the ability to re-auction their Financial Value as certain critical events or milestones are reached or achieved.

6) Allow customers to update their Financial Value to represent changes in their circumstances as a customer.

Financial Value is the ultimate market segmentation. It identifies a Buyer Profile and set of criteria that can be communicated and matched with existing vendors. It increases the opportunity for businesses to accurately identify the most profitable customers, reduces the redundant costs of attracting unprofitable customers, and permits the enterprise to pass along and reward the customer with better prices or improved services. Lower prices, niche products, improved services, etc. reflect the target customers Financial Value and distinguish them from other, less important and clearly unprofitable customers.

These and other embodiments of the disclosed subject matter, as well as additional novel features, will be apparent from the description provided herein. The intent of this summary is not to be a comprehensive description of the subject matter but rather to provide a short overview of some of the subject matter's functionality. Other systems, methods, features and advantages provided herein will become apparent to one with skill in the art upon examination of the following FIGURES and detailed description. It is intended that all such additional systems, methods, features and advantages that are included within this description, be within the scope of any claims to be included with any non-provisional application claiming the benefit of this disclosure.

### BRIEF SUMMARY OF THE INVENTION

The disclosure herein provides a method and system of auctioning a customer's Financial Value via a full-time public network. Other aspects, embodiments, objectives, and advantages of the disclosure will become more apparent from the detailed description of the illustrative embodiments when taken in conjunction with the accompanying drawings.

One consequence of employing the methods and systems detailed in the present disclosure is the more effective and efficient determination of which customers will be the most valuable for different vendors. The enabling of vendors to determine and bid on valuable customers, and simultaneously avoid the pursuit of customers who would likely not be valuable to the vendors, thereby reducing the vendor's marketing costs and, which can then passed on to the customers.

Additionally, the present disclosure provides a system and method for customers to be able to market their particular needs to the vendors who would be best-suited to fulfill said customer's needs. Furthermore, the customers would benefit from the reduced cost of vendor products and/or services that result from the more targeted marketing and sale of vendor products.

A further benefit of many embodiments of the present disclosure is that the vendors and customers having been matched to each other would have reason to enjoy improved confidence that transaction execution has been satisfactory. This differs from current practice in which only the broker between the vendor and customer truly knows the quality of execution.

Customers using the present disclosure may identify products and/or services that they wish to acquire from a vendor. They then use a computing device to create and store a customer profile for themselves that designates the desired goods and/or services and further includes any information that may be relevant to the customer's desired purchase, including but not limited to, customer preferences or specific qualities of the desired goods and/or services. The more relevant information that the customer includes in the customer profile, the more the valuable that content may be in the matching and bidding process to be discussed later, which may result in the increased precision of said matching.

Similarly, vendors using the present disclosure may identify the products and/or services that they are able to offer to potential customers. The vendors then use a computing device to create and store a vendor profile. The vendor profile contains information related to the goods and/or services offered by the vendors and any further information that may be relevant to determining the market segment that the vendor creating the vendor profile may intentionally, or unintentionally, be targeting.

Once the customer and vendor profiles are created they may be stored in a database (e.g. an online/cloud database, physical database, electronic database, etc.). The system may then perform a matching service that associates vendor and customer profiles based on the correlation between the information provided in the respective profiles. The more information provided by each party, the more accurately this matching may perform. This matching process may be achieved by any number of matching-methods known in the art (e.g. the application of one or more algorithms, or the correlation between the information provided in the customer and vendor profiles respectively, etc.).

Once the customer profiles have been matched with vendor profiles through the matching system, the best matched customer profiles associated with a particular vendor profile may be displayed to the vendor (the customer profiles may be ranked in a hierarchy based on the correlation of the match with the vendor profile). The system may then enable vendors to bid (make offers to the customers) based on the customer profiles matched with their vendor profile. These vendor bid and their associated vendor profiles are then transmitted to the customers associated with the customer profiles being bid on. The customers may then view the vendor profiles of the vendors that bid on their customer profile and identify which of those bids may be acceptable. The customer may then use the system to select a winning bid from the acceptable vendor bids.

Once a winning vendor bid is selected by a customer, the vendor associated with that vendor profile is notified, and a transaction between the customer and vendor is facilitated.

In some embodiments, the customer and vendor profiles may include the option to have the information (e.g. name, physical address, telephone number, etc.) contained therein hidden from other parties involved in the process until a winning bid has been submitted and selected. This may allow for the parties to keep information (including, but not limited to, the identities of the parties) from being discoverable by all parties involved in the matching and bidding process. This may allow the parties to remain anonymous until the winning bid is selected, at which time the parties identities may be disclosed only to the party with which they are transacting business.

In summary, this disclosure delineates a method, system, and software for enabling and facilitating a matching between a customer and a vendor through a full-time public network. The method disclosed herein consists of determining a Financial Value of said customer, wherein the customer's Financial Value is determined in reference to the correlation of a match analysis between a good and/or service sought by the customer and a good and/or service offered by a vendor. The customer and vendor input information related to the goods and/or services that are either seeking or offering into profiles that are received by a computer system. The information stored in such customer and vendor profiles can be used to determine market segments, Financial Values, and match customer profiles with vendor profiles, and vice versa, based on how the correlation between the sought and offered goods and/or services, and the customer or vender preferences associated with said goods and/or services. The computer system runs a match analysis between customer and vendor profiles and displays to the user profiles that correlate, or are compatible with, the information that that user has in their own profile. This match analysis may be through the application of one or more algorithms, which may be performed by a computer system. The profiles displayed to the user may be ranked in an order showing the comparative amount of correlation between the profiles. Once the closely correlated profiles are displayed to the user, the user may bid on a correlated profile. If the bid submitted by the user meets the qualities necessary for the transaction, the bid is accepted by the computer system. Once one or more accepted bids on a profile have been submitted, the party associated with the profile being bid on may select one of the accepted bids as a winning bid. Once a winning bid has been selected, the computer system facilitates the transaction between the party associated with the profile that submitted the winning bid and the party associated with the profile that selected the winning bid by exchanging between those parties additional information, which may include but is not limited to, the party's identity, other identifying information, contact information, etc.

### BRIEF DESCRIPTION OF THE DRAWINGS

The disclosed subject matter itself, as well as a preferred mode of use, further objectives, and advantages thereof, will best be understood by reference to the following detailed description of an illustrative embodiment when read in conjunction with the accompanying drawings, wherein:

FIG. 1 illustrates a general purpose computing system that may be part of a full-time public network of such computing systems for employing the method and system for businesses to acquire profitable customers.

FIG. 2 illustrates the types and categories of customer and business information and (in this example) the types of financial products that may be captured or inputted by customers and vendors into the system.

FIG. 3 demonstrates (in this case a financial product) the high-level information flow of the profiles and preferences that may be inputted for matching by the system, to enable customers and vendors to seek and identify the best match for desired goods/services, criteria, descriptions, characteristics, and all other data.

FIG. 4 depicts a flow chart illustrating an exemplary methodology as disclosed for establishing customer and vendor profiles.

FIG. 5 depicts a flow chart illustrating an exemplary method for using a full-time public network to facilitate the matching of customer profiles and vendor profiles, vendors bidding on customer profiles, and determining a winning vendor bid.

FIG. 6 depicts a flow chart illustrating an exemplary method of using the disclosed system for facilitating optimal customer and vendor profile matching.

FIG. 7 depicts an electronically connected network (an exemplary environment) capable of supporting the method and system of the present disclosure for auctioning funds using a full-time public network in an embodiment of the present invention.

The FIGURES and their descriptions, above, are designed to illustrate examples of the subject matter being disclosed herein, and to clarify the manner in which the disclosed materials operate. These FIGURES and their descriptions are not intended to limit the scope of the disclosure in any way.

### DETAILED DESCRIPTION OF ILLUSTRATIVE EMBODIMENTS

Reference now should be made to the drawings, in which the same reference numbers are used throughout the different FIGURES to designate the same components.

Although described throughout this disclosure with particular reference to financial institutions, the subject matter is intended to encompass any undertaking where identifying potential customers is of importance. As such, the use of these particular FIGURES is exemplary and is not intended to limit the disclosure made herein in any manner. Those with skill in the arts will recognize that the disclosed embodiments have relevance to a wide variety of areas in addition to those specific examples described below.

The disclosure herein provides a method and system for customers to identify their Financial Value and to auction this value via a full-time public network to selected service and product providers (“vendors”) seeking customers with specific profiles. Due to the significant cross selling opportunity to sell financial services to qualified and profitable segments of customers, it is anticipated the major application of the material contained in this disclosure is likely to be with customers seeking goods and/or business services and especially those seeking financial services. A critical distinguishing factor in the disclosure is that the traditional marketing process of advertising and offering a product is reversed, such that customers can, through the use of the disclosed system and method, identify their own Financial Value and auction it to vendors.

As much as 80% of customers attracted through advertised deposit rates are not profitable due to ineffective customer segment identification, yield chasers, and low account balances. Profitable customers pay for this inefficiency with reduced quality and/or higher costs. This disclosure solves these problems. With the information included in this disclosure every customer can create and auction to vendors in the marketplace their own Financial Value. Through this auction process, vendors may be able to find profitable customers and reward them by bidding up their value. This value offered in said bidding process may take various forms, such as, but not limited to lower product prices, or, for example, in the case of a bank, it may be higher deposit rates, reduced loan rates, or better service fees.

The Financial Value associated with a customer changes constantly. Factors that may influence a customer's Financial Vale may include, but are not limited to, a change in employment or employment status, pay increase, or new client, may increase a customer's value to a business. With the material contained in this disclosure, customers are able to continually update their profile and add information and knowledge to the system, refining and increasing their Financial Value to participating businesses. The more information a customer inputs into the system the higher that customer's Financial Value to the market.

Customer profiles are matched with vendor profiles based on the amount and correlation between the customer profile information, which determines the customer Financial Value, and the vendor profile information, which indicates the goods and/or services that a vendor can provide and the customer segments that the vendor is targeting. This matching of customer and vendor profiles may be achieved through the application of algorithms, or any other means designed to facilitate identification of customer profiles related to vendor preference, and/or identification of vendor profiles related to customer preferences.

The process described herein is far more effective than traditional methods of 1) mining old data, 2) making prediction models that become quickly outdated and whose accuracy is questionable, or 3) attracting more customers, including those that they do not seek through the use of broad customer marketing. With the system's auction marketplace, businesses are able to bid on customers that are identified as having a very high potential for cross-selling with existing or new products.

In some embodiments the use of the system may require business to pay a customer acquisition fee that could vary depending on the number of data-point matches between the business profile and the customer profile.

In an embodiment of the disclosed subject matter, businesses only attract and bid on profitable customers.

In another embodiment of the disclosed subject matter, the interaction between businesses and customers may be anonymous, based on profiles and preferences that do not include the associated users' identity. The users may thereby remain anonymous until a winner is determined and terms are established.

In another embodiment of the disclosed subject matter, bidding and acceptance may be done on a profile by profile basis. Accordingly, the unprofitable “mass market” offer may be eliminated.

In another embodiment of the disclosed subject matter, significant customer acquisition cost savings may be achieved by tailoring customer acquisition and marketing for excluding unprofitable customers.

Another embodiment of the disclosed subject matter may protect the identity of the vendors and/or customers using the system. In such an embodiment, exchanges may be based on profiles that may be configured to maintain anonymity. This stealth marketing allows businesses to prevent disclosure of their market to their competitors, i.e. which high value segments they are pursuing and/or acquiring.

In another embodiment of the disclosed subject matter, the disclosed subject matter creates customization for its users. It enables the building of a “mass market of one” for financial products and profitable customer segments. Businesses can continually acquire customers in profitable, micro-targeted segments and serve them with new and innovative products at minimal costs.

In another embodiment of the disclosed subject matter, customers can utilize any of a plethora of criteria in making their product decision. For example, a potential consumer may wish to do business only with a business that has a foreign language capability, or one that offers products that meet certain specific needs.

In another embodiment of the disclosed subject matter, the customer's experience with the interface, their identification of the right companies for their needs, and the ability for them to rate services and talk with other users is a critical retention tool and works to create a community within the auction marketplace.

In another embodiment of the disclosed subject matter, the system enables businesses to be able to target specific profitable customer segments, such as a particular ethnic group (or type), or owners of small businesses. The ability to identify and attract customers with incremental services or additional products significantly reduces marketing and acquisition costs and leads to the establishment of profitable customer relationships.

This auction system based on customer identified Financial Value enables companies to abandon old methodologies for acquiring customers and types of customers. The consumers are able to examine themselves, identify, and assess their own strengths, and thereby effectively and logically align with compatible vendors.

In one embodiment, the system may enable an auction provider to earn a customer acquisition fee on all customers that meet a business' specific criteria.

The following flowcharts and FIGURES help describe the process, method, and system in more detail.

### From the Customer Perspective

For a customer, the system provides invaluable assistance. By permitting a customer to enter data that it knows will attract vendors to her, and allowing that customer to accept and review bids on products the vendors bid on, the customer can be reasonably assured she is getting the best price based on their particular circumstances. This allows the customer to interact with the vendor in a far more transparent basis than what normally occurred before. It also assures the customer that she is being dealt with on an individual basis, rather than in a purely statistical manner.

When generating a Buyer Profile, customers will populate fields of information based on a variety of forms. These forms may include different types and formats of questions.

Questions and/or data fields included will typically start with basic information and, depending on answers, and at option of users, will progress to either detail, specific, or deep levels. The information collected will form the preferences and profiles of each user, which may be a business, an individual, a family, a group of users, etc. Each such user set of data is called a “profile”. All user identity may be protected until the user releases the information. The user may have the option to suppress certain answers or categories of answers.

Each request for information, or question, can be explained in terms of the benefit and value to the customer. Interrelationships between questions may also be explained. For example, should one of the questions be about family structure, such as “Do you have children at college?”, with a specific question of “How do you pay for college?”, the service could explain that this information might enhance a customer's value to a bank that might wish to offer them student loans (especially if the customer indicated they had cash-flow difficulties). If, in addition, the customer also indicated they supported an aging parent who had equity in their home, this customer could have very significant Financial Value to a bank willing to offer a Reverse Mortgage to the surviving parent and relieve the family of cash-flow pressures. Such relationships may be explained to the users so as to communicate the associated customer information might have significant value to a vendor.

From the Business/Supplier/Vendor Perspective

The concept of Financial Value to a business or vendor enables a business to translate its customer Profile into usable data points. It also requires or forces a business to validate what elements of a customer profile indicate higher profitability or propensity to purchase certain products and/or services. For example, a bank knowing that customers from a certain zip code who own houses and are from a certain ethnic group always pay their debts on time, it may seek to identify customers in this system with similar profiles and bid on their financial products. For example, should one of these profiles be looking to maximize a yield by auctioning a $100,000 deposit for 6 months, the bank can make a determination if it will offer the very best rate to get that deposit because it knows it can also offer very competitive rates on (say) a credit card to the same Profile. This method may be preferable in the eyes of the vendor as compared to advertising and paying a very high rate on all deposits from customers, including customers that the bank may not wish to serve.

One of the major features of the disclosure is the creation of a Financial Value Score (“FVS”) for each customer using the system. This score may be embodied as an interactive summary created from the data inputted by the customer into the system. In some embodiments, the score may be numerical. In some embodiments, the higher the score, the higher the likely return on marketing, the likelihood of cross selling, and profit potential of the associated customer. Algorithms can be used to calculate various components of the score based on the data supplied. As more information is inputted into the system, the FVS may be adjusted accordingly in “real time” so the customer can measure the effects of providing data to the system.

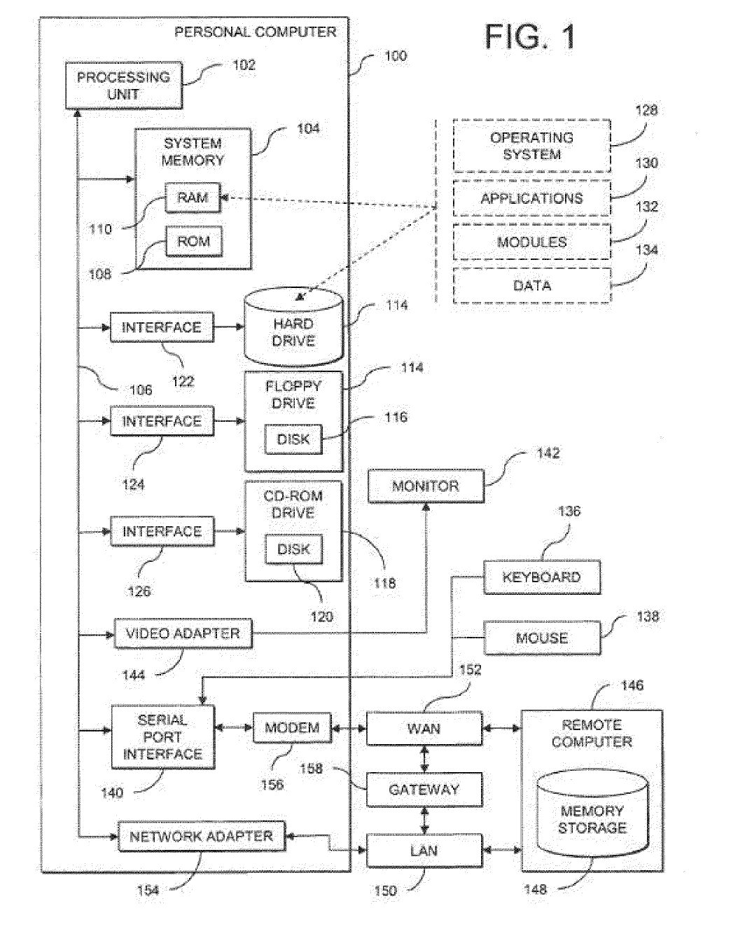

FIG. 1 illustrates a general purpose computing system (also known as a computer, or computing device) that may be part of a network of such computing systems for employing the method and system for businesses to acquire profitable customers. By associating a network of general-purpose computers 100, the present disclosure facilitates businesses acquisition of profitable customers using an auction-based protocol over a full-time public network. In such an electronic environment as established by the present disclosure, at least two such computers may be operated at different locations within a given geographical or similarly bounded area.

With reference to FIG. 1, general-purpose computer 100 may be a personal computer, a laptop, palmtop, or other set top, server, mainframe, and other variety computer, and include processing unit 102, system memory 104, and system bus 106 coupling various system components including system memory 104 to the processing unit 102. Processing unit 102 may be any of various commercially available processors. Dual microprocessors and other multi-processor architectures also can be used as the processing unit 102. System bus 106 may be any of several types of bus structures including a memory bus or memory controller, a peripheral bus, and a local bus using any of a variety of conventional bus architectures. System memory 104 includes read only memory (ROM) 108 and random access memory (RAM) 110. A basic input/output system (BIOS), containing the basic routines helping to transfer information between elements within the computer 100, such as during start-up, is stored in ROM 108. Computer 100 further includes a hard disk drive 112, a floppy drive 114, e.g., to read from or write to a removable disk 116, and CD-ROM drive 118, e.g., for reading a CD-ROM disk 120 or to read from or write to other optical media. The hard disk drive 112, floppy drive 114, and CD-ROM drive 118 are connected to the system bus 106 by a hard disk drive interface 122, a floppy drive interface 124, and an optical drive interface 126, respectively. The drives and their associated computer-readable media provide nonvolatile storage of data, data structures, computer-executable instructions, etc., for computer 100. Although the description of computer-readable media provided above refers to a hard disk, a removable floppy and a CD, those skilled in the art may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 110, including an operating system 128, one or more application programs 130, other program modules 132, and program data 134. A customer may enter commands and information into the computer 100 through a keyboard 136 and pointing device, such as mouse 138. Other input devices (not shown) may include a microphone, joystick, game pad, satellite dish, scanner, or the like. These and other input devices are often connected to the processing unit 102 through a serial port interface 140 coupling to the system bus, but possibly connecting by other interfaces, such as a parallel port, game port or a universal serial bus (USB). A monitor 142 or other type of display device is also connected to the system bus 106 via an interface, such as a video adapter 144. In addition to the monitor, computers typically include other peripheral output devices (not shown), such as speakers and printers.

Computer 100 may operate in a networked environment using logical connections to one or more remote computers, such as a remote computer 146. Remote computer 146 may be a server, a router, a peer device or other common network node, and typically includes many or all of the elements described relative to the computer 100, although only a memory storage device 148 has been illustrated in FIG. 1. The logical connections depicted in FIG. 1 include a local area network (“LAN”) 150 and a wide area network (“WAN”) 152. Such networking environments are commonplace in offices, enterprise-wide computer networks, intranets and the Internet.

When used in a LAN networking environment, the computer 100 is connected to the LAN 150 through a network interface or adapter 154. When used in a WAN networking environment, computer 100 typically includes a modem 156 or other means for establishing communications (e.g., via the LAN 150 and a gateway or proxy server) over the wide area network 152, such as the Internet. Modem 156, which may be internal or external, is connected to the system bus 106 via the serial port interface 140. In a networked environment, program modules depicted relative to the computer 100, or portions thereof, may be stored in the remote memory storage device 148.

When used in a LAN networking environment, the computer is connected to the LAN through a network interface or adapter. When used in a WAN networking environment, computer typically includes a modem or other means for establishing communication over the WAN, such as the Internet. Modem, which may be internal or external, is connected to the system bus via the serial port interface. In a networked environment, program modules depicted relative to the computer, or portions thereof, may be stored in the remote memory storage device.

The general purpose computing system depicted in FIG. 1 is an example of the type of computing system that customers and/or vendors may use in order to create their profiles, associate information with said profiles, and interact with the matching and auctioning system.

Those skilled in the art may appreciate the network connections shown as being exemplary, wherein other means of establishing a communications link between the computers may be used. FIG. 1 provides only one example of a computer useful for employing the teachings of the present disclosure. The disclosure may be used in computers other than general-purpose computers, as well as on general-purpose computers without conventional operating systems.

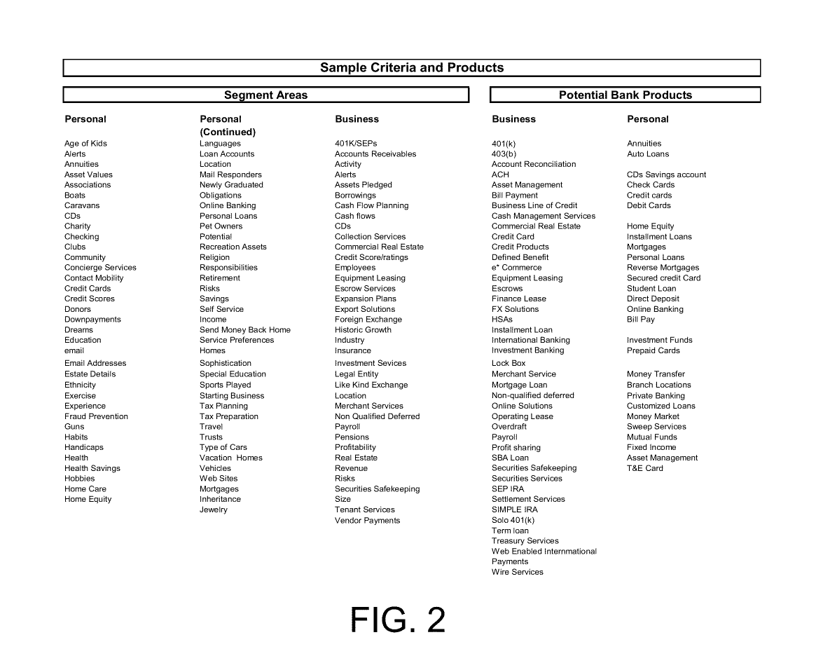

FIG. 2 displays examples of the type of customer or vendor information that may be inputted into the system and is by no means intended to exhaustive. While the present example includes information relevant to financial products, it is not intended to limit the disclosure and could easily be adapted for other products and/or services. Basic product rules may also be inputted, as well as customer service expectations or service maintenance requirements. Any and all information inputted into a customer or vendor profile that may be relevant to determining the customer's Financial Value or the vendor's target customer profile may be considered “Profile Information”.

Any information inputted into the system, including the customer or vendor profiles that are related to the identity of participants may be maintained as confidential during the auction. This confidentiality may provide value to participants who do not wish others to know of their auction participation activities. For example, banks often have an interest in keeping auction activity confidential from competing intuitions. Accordingly, the use of embodiments of this disclosure as a market mechanism may offer complete anonymity to all participants until such time as there is a winning bid. Even after a winning bid is accepted the anonymity of the parties involved may only be maintained outside of the parties entering into the associated transaction.

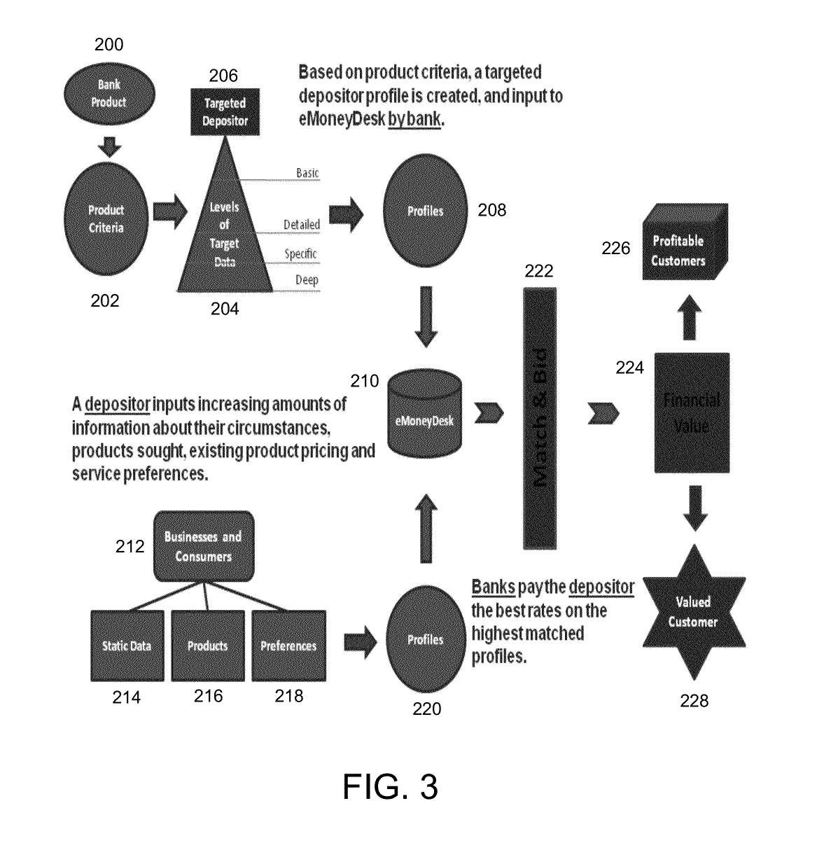

FIG. 3 shows a flow chart of an exemplary process as described in this disclosure. This example depicts a bank as an exemplary vendor and businesses and consumers as exemplary customers. This example is not intended to limit the application to this embodiment. a vendor inputs certain basic or detailed customer segment information. A potential customer may input information to form their profile and preferences as determined by the system. The diagram shows the system matching all this data to provide the best and most profitable customer for the vendor, as well as the best service match, and pricing for the customer.

With reference to the flow chart depicted in FIG. 3, a vendor identifies the goods and/or services 200 that they offer to their customers. These goods and/or services 200 then have associated product criteria 202 that may be used to determine the market segment 206 and related customer information best suited for their goods and/or services. Once the vendor's market segment 206 is determined, information related to the market segment 204 may be inputted into a vendor profile 208. The vendor profile 208 may then be transferred to a database 210.

Similarly, a customer 212 using the disclosed system may determine the goods and/or services 216 that they desire along with their preferences 218 associated with said goods and/or services. Information related to the customer desired goods and/or services 216 and customer preferences 218 are then inputted into a customer profile 220, which may thereafter be transferred to a database 210.

Once the database 210 has received vendor profiles 208 and customer profiles 220 the system then conducts the matching of customer profiles 220 with vendor profiles 208 based on the information included said profiles 204, 214, 216, and 218. After the matching of customer profiles 220 and vendor profiles 208, vendors may bid on customers based on the customer's Financial Value 224 as interpreted by the vendors based on the correlation of the matching of information contained in the customer profiles 220 and vendor profiles 208. By allowing vendors to bid on customers who have a high level of matching with their vendor profile 208, vendors are better able to secure profitable and valued customers 229 and 228.

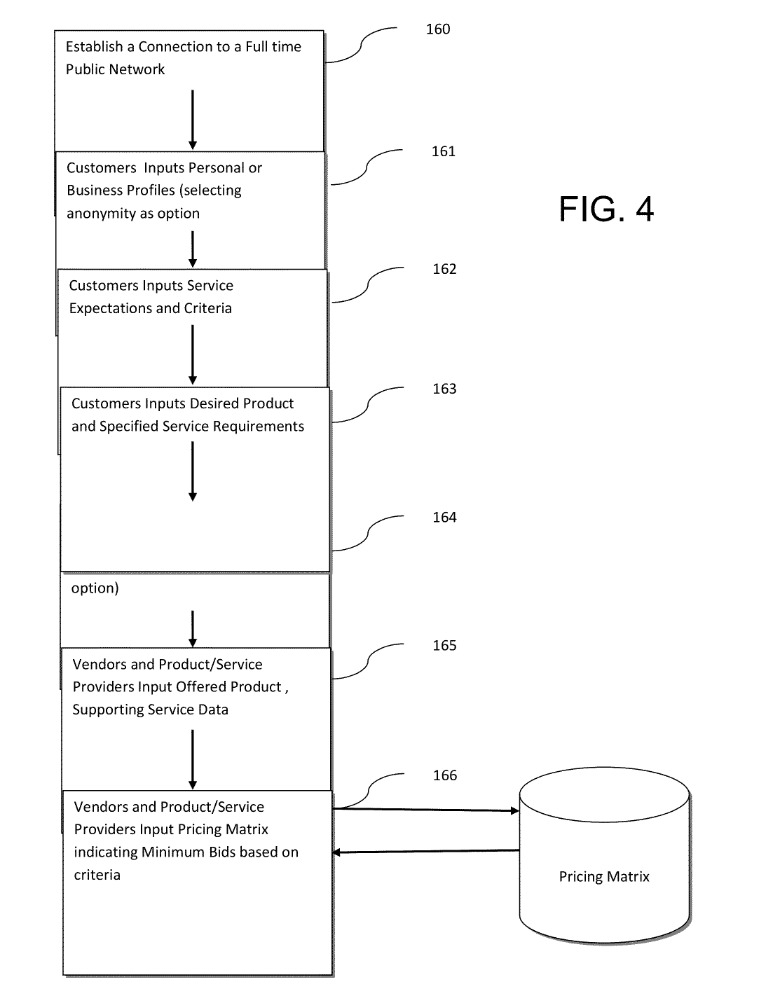

FIG. 4 depicts an exemplary method of employing the disclosed subject matter. Customers and vendors access the system 160 through a full-time public network, for example the Internet. Customers may voluntarily input 161 as much information as they are comfortable into a matrix of basic, detailed, specific and ultimately very deep stratus of information. At this point the system may enable customer to select to be anonymous customers. Customers may also input 162 and 163 the products they seek, and any related service criteria. Vendors may also select an option to be anonymous. Vendors also access the system 164 and input customer target information that will identify the desired and profitable customer segment. Vendors also input product and/or service data in to the system 165. This data may be accepted into the system through a different set of screens more suitable to extracting customer segment information. The vendor further inputs the minimum opening bid pricing into the matching computer system 166. This module controls the initial bid shown to the customer in the auction room when their need is identified to the vendor.

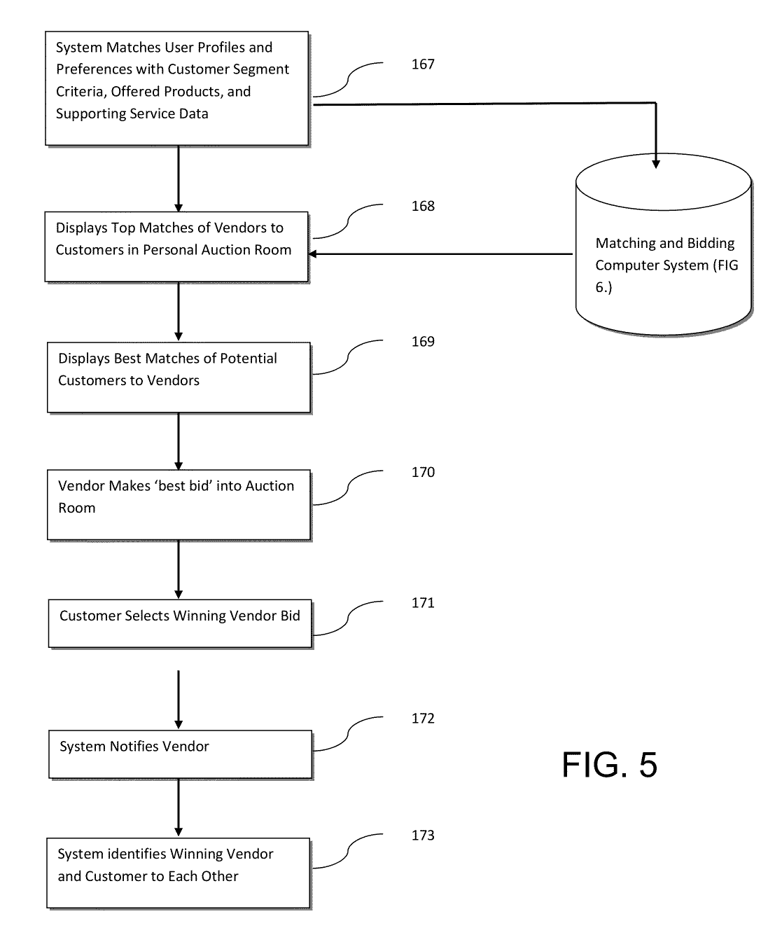

FIG. 5 shows an exemplary Matching and Bidding System 167, which can evaluate and match the User Profiles and Preferences with the Customer Segment Criteria, Offered Products, and Supporting Service Data. The system may identify the “best match” vendor to the customer based on the Financial Value Score (“FVS”) and other criteria. The system may display these “best matches” in an auction room 168 which may be visited by the customer and the vendor. The auction room may also show on the vendor's screens 169 the list of potential customers meeting the vendor's criteria. The vendor can enter each Customer's virtual auction room 170 and increase the bid, making a “best bid” against other vendors. The customer selects the winning bid based on their criteria 171 (the winning bid does not have to be highest bid). The system notifies both parties 172 and if necessary identifies the winning vendor and winning customer to each other 173.

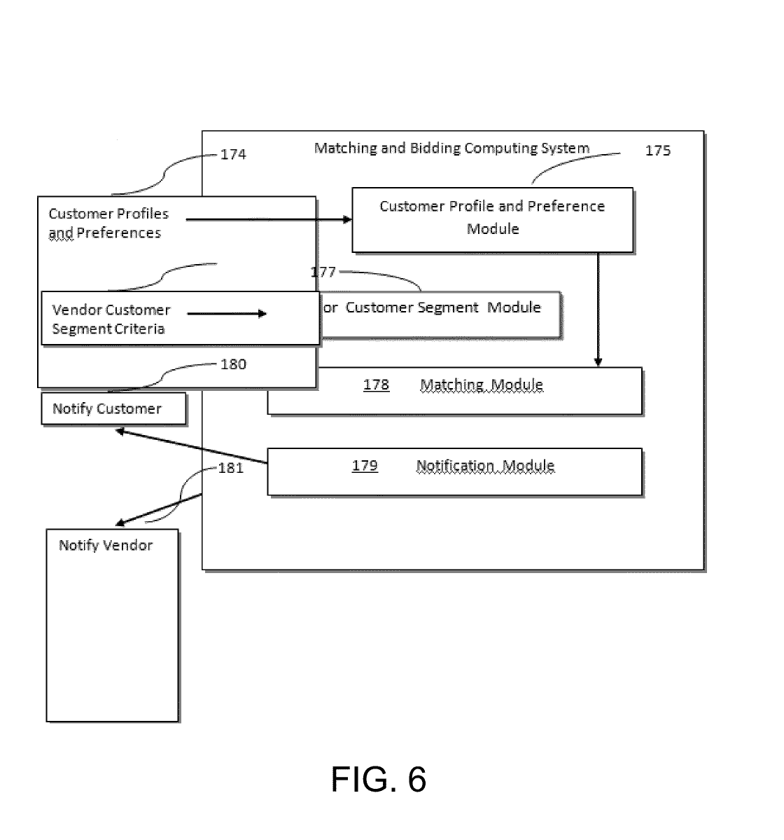

FIG. 6 displays an exemplary basic matching and bidding computing system. The customer profiles and preferences 174 may be inputted into the Customer Profile and Preference Module 175 through the internet connectivity. The vendor inputs their criteria for customer segmentation 176 into the Vendor Customer Segment Module 177 also through the internet connectivity. A specially designed Matching Module 179 with the ability to run various algorithms against the data to find “best match” identifies in order of a predetermined selected sort criteria and identifies these matches by notifying the customer 180 and the vendor 181 that an auction is now in process.

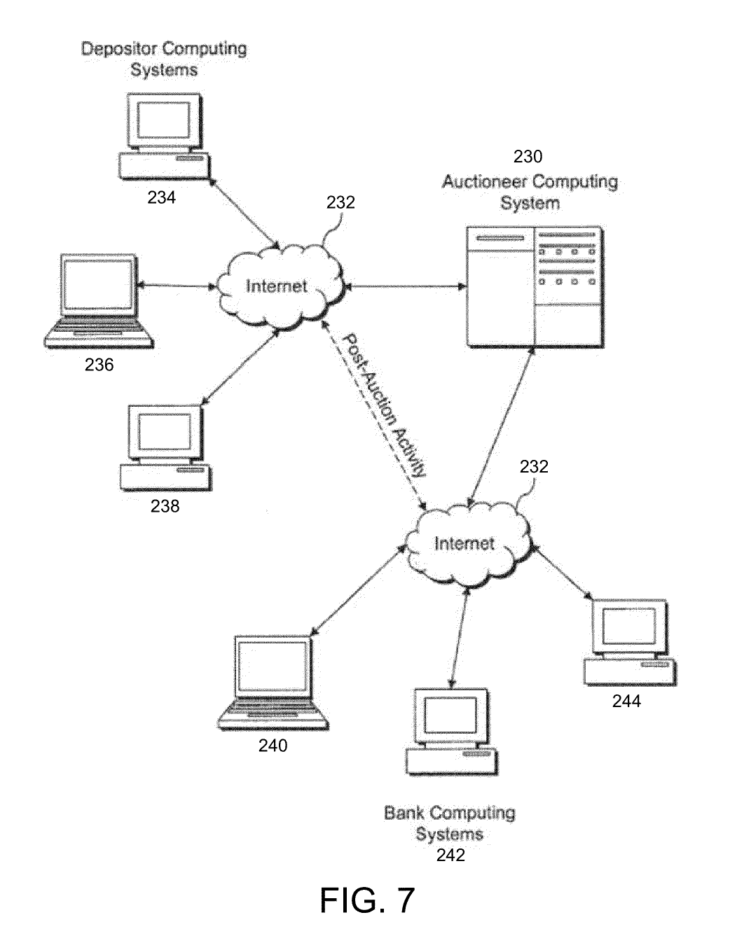

FIG. 7 illustrates an exemplary electronically connected network environment that is capable of supporting the auctioning of customers' Financial Value to vendors through a full-time public network. Customer computing systems 234 upload customer profiles to an auctioneer computing system 230 through a full-time public network 232. Vendor computing systems 242 upload vendor profiles to an auctioneer computing system 230 through a full-time public network 232. Auctioneer computing system 230 can then match the customer and vendor profiles and exchange bid an acceptance information between customer computing systems 234 and vendor computing systems 242 through the full-time public network 232.

1. A method of facilitating a matching between a customer and a vendor through a full-time public network comprising:
determining a Financial Value of said customer, said determination comprising:
identifying one or more of a good and a service sought by said customer;
identifying a piece of customer information, wherein said piece of customer information associates to said one or more of a good and a service sought by said customer;
creating a customer profile, said customer profile comprising said piece of customer information; and
determining a market segment, said determination comprising:
identifying one or more of a good and a service offered by said vendor;
identifying a piece of vendor information, wherein said piece of vendor information associates to said one or more of a good and a service offered by said vendor;
creating a vendor profile, said vendor profile comprising said piece of vendor information; and
auctioning said Financial Value to said vendor through an auctioning process comprising:
establishing a connection to the full-time public network;
receiving said customer profile via the full-time public network;
receiving said vendor profile via the full-time public network;
performing a match analysis between said customer profile and said vendor profile;
displaying said customer profile to said vendor based on the correlation of said match analysis;
receiving a bid from said vendor on said customer profile via the full-time public network;
receiving an accepted bid said by said vendor via the full-time public network; and
receiving a selection of an accepted bid as a winning bid.

2. The method of claim 1, wherein said match analysis between said customer profile and said vendor profile through the full-time public network, is performed by the application of an algorithm.

3. The method of claim 1, wherein said match analysis between said customer profile and said vendor profile through the full-time public network, is performed by the application of more than one algorithm.

4. The method of claim 2, wherein said application of said algorithm is performed by a computer system.

5. The method of facilitating a matching for a customer with a vendor through a full-time public network of claim 1, wherein said match analysis between said customer profile and said vendor profile is based on the compatibility between said piece of customer information and said piece of vendor information.

6. The method of claim 1, wherein said match analysis between said customer profile and said vendor profile is based on the compatibility between said Financial Value and said market segment.

7. The method of claim 1 further comprising:
notifying the vendor who submitted said winning bid of the identity of the customer having said customer profile; and
notifying said customer of the identity of the vendor having the vendor profile that submitted said winning bid.

8. The method of claim 1, wherein said customer profile does not disclose information related to the identity of said customer to said vendor until after said winning bid has been selected.

9. The method of claim 1, wherein said vendor profile does not disclose information related to the identity of said vendor to said customer until after said winning bid has been selected.

10. The method of claim 1, wherein one or more of said customer and said vendor remain anonymous until said winning bid has been selected.

11. The method of claim 1, wherein said winning bid is not the lowest priced bid.

12. The method of claim 1, wherein the full-time public network is the Internet.

13. A system for facilitating customer and vendor matching comprising:
a full-time public network;
one or more computing devices communicably connected to said full-time public network; wherein at least one of said one or more computing devices contains information on a customer, and at least one of said one or more computing devices contains information on a vendor; and
a computer system communicably connected to said full-time public network, wherein said computer system is configured to:
determine a Financial Value of said customer, said determination comprising:
identifying one or more of a good and a service sought by said customer;
identifying a piece of customer information, wherein said piece of customer information associates to said one or more of a good and a service sought by said customer;
creating a customer profile, said customer profile comprising said piece of customer information; and
determine a market segment, said determination comprising:
identifying one or more of a good and a service offered by said vendor;
identifying a piece of vendor information, wherein said piece of vendor information associates to said one or more of a good and a service offered by said vendor;
creating a vendor profile, said vendor profile comprising said piece of vendor information; and
auction said Financial Value to said vendor through an auctioning process comprising:
establishing a connection to the full-time public network;
receiving said customer profile via the full-time public network;
receiving said vendor profile via the full-time public network;
performing a match analysis between said customer profile and said vendor profile;
displaying said customer profile to said vendor based on the correlation of said match analysis;
receiving a bid from said vendor on said customer profile via the full-time public network;
receiving an accepted bid said by said vendor via the full-time public network; and
receiving a selection of an accepted bid as a winning bid.

14. The system of claim 13, wherein said information on a customer comprises a Financial Value.

15. The system of claim 13, wherein said information on a vendor comprises market segment information.

16. The system of claim 13, wherein said match analysis is achieved through the application of an algorithm.

17. The system of claim 13, wherein said match analysis is achieved through the application of more than one algorithm.

18. The system of claim 13, wherein said full-time public network is the Internet.

19. The system of claim 16, wherein said application of said algorithm is performed by said computer system.

20. Software for facilitating customer and vendor matching through a full-time public network comprising:
an executable program stored on a non-transitory computer readable medium, said executable program, which when executed is configured to:
determine a Financial Value of said customer, said determination comprising:
identifying one or more of a good and a service sought by said customer;
identifying a piece of customer information, wherein said piece of customer information associates to said one or more of a good and a service sought by said customer;
creating a customer profile, said customer profile comprising said piece of customer information; and
determine a market segment, said determination comprising:
identifying one or more of a good and a service offered by said vendor;
identifying a piece of vendor information, wherein said piece of vendor information associates to said one or more of a good and a service offered by said vendor;
creating a vendor profile, said vendor profile comprising said piece of vendor information; and
auction said Financial Value to said vendor through an auctioning process comprising:
establishing a connection to the full-time public network;
receiving said customer profile via the full-time public network;
receiving said vendor profile via the full-time public network;
performing a match analysis between said customer profile and said vendor profile;
displaying said customer profile to said vendor based on the correlation of said match analysis;
receiving a bid from said vendor on said customer profile via the full-time public network;
receiving an accepted bid said by said vendor via the full-time public network; and
receiving a selection of an accepted bid as a winning bid.
